(19) United States
(12) Patent Application Publication
(10) Pub. No.: US 2002/0146662 A1
(43) Pub. Date: Oct. 10, 2002

(54) Syringe-type material supply device

(75) Inventors: Andreas Radl, Vazuz (LI); Gabriela Bopp, Gofis (AT); Bruno Senn, Buchs (CH); Frank Muller, Feldkirch (AT)

Correspondence Address: John C. Thompson, 69 Grayton Road, Tonawanda, NY, 14150, US

(73) Assignee: Ivoclar Vivadent AG

(21) Appl. No.: 10/072,086

(22) Filed: Feb. 8, 2002

Related U.S. Application Data
(60) Provisional application No. 60/296,619, filed on Jun. 7, 2001.

(30) Foreign Application Priority Data
Apr. 6, 2001 (DE) P 101 17 385.7

(51) Int. Cl. A61C 5/04

(52) U.S. Cl. 433/90; 604/187; 604/191

(57) ABSTRACT

A syringe-type device for supplying dental material to a dental restoration site includes a syringe body, a syringe connecting body, and an activation component. The syringe body has an outlet and a dental material retaining space for retaining therein a dental material. The syringe connecting body has an upstream opening and a downstream opening and is connectable to the syringe body such that dental material which has exited the syringe body through the outlet thereof flows through the upstream opening into the syringe connecting body and subsequently flows through the downstream opening to the dental restoration site. The activation component is disposable at the outlet of the syringe body and, in a non-actuated condition thereof, at least partially blocks the flow of dental material from the syringe body into the syringe connecting body and, in an actuated condition thereof, permits a relatively greater flow of dental material.

### BACKGROUND OF THE PRESENT INVENTION

The present invention relates to a syringe-type material supply device.

German Patent Application 100 64 005.2 discloses a two-component syringe-type material supply device which is particularly configured to hold ready a supply of viscous dental material, especially root canal filling material, and to dispense such material as required. The supply of the dental material is effected by a vacuum in the syringe connecting body. This approach offers the particular advantage that entrapped air in the dental material can be foreclosed to a large degree, in that the vacuum also effects the drawing out of flowing material components ahead of time, so that the tendency of the material to create air bubbles is relatively low.

It has further been conventionally known to deploy syringe-type material supply devices for dental material, which are specifically configured to facilitate the hand application of the dental material. In this context, one distinguishes between so-called single dose units and syringe-type material supply devices for multiple uses. Single dose units have the advantage of simple usability, in that no clean up steps are required and they are thrown away after use.

In connection with the use of syringe-type material supply devices as dental material supply holders, the dosing capability is good in that the dental technician or, more commonly, the dentist, can make ready an exact desired amount of dental material via controlled movement of the syringe plunger. With such syringe-type material supply devices, the outlet is completely closed in order to avoid the entry of debris or other non-hygienic material.

Moreover, it has been conventionally known to use so-called two component syringe-type material supply devices in which two separate dental material components are each kept ready for use in respective syringe-type material supply device canals. For the use of such dental material, it is important that a good cross mixing of the materials is performed. In this connection, special combined dosing and mixing devices are known which ensure a good cross mixing of the components. An approach, which is particularly cost favorable in its production costs is disclosed in German Patent Application 100 64 005.2, in which a static mixer is disposed in the syringe connecting body, whereby the syringe connecting body is locked against rotation relative to the syringe body and the static mixer is preferably so configured that it does not turn at all, or turns, at the most, only insignificantly, within the syringe connecting body. By passage through the static mixer, the material is subjected to shearing forces which ensure a good cross mixing of the two components. A static mixer is, however, suggested only as a preferred device; there are other mixing devices which can also be deployed.

A heretofore unsolved problem, in connection with the supply retainers of dental materials, is the problem of entrapped air. Entrapped air can lead to defective dental restorations.

It has already been suggested to effect the withdrawal of the dental material via a vacuum from the syringe body. In this connection, the tendency of the dental material to entrap air is somewhat reduced. It would, however, be desirable to be able to exclude the entrapment of air with a greater degree of reliability, especially in connection with root canal filling material.

### SUMMARY OF THE INVENTION

The present invention offers a solution to the challenge of providing a syringe-type material supply device which is capable of supplying viscous dental material and which provides an improved reliability against the entrapment of air, whereby the dental material can be delivered in a pre-dosed manner and the syringe-type material supply device can be produced in a relatively simple production process which is cost favorable.

The syringe-type material supply device of the present invention, configured with surprisingly simple components, makes possible the holding ready of a supply of dental material which has a particularly low tendency toward entrapment of air. By selective actuation of the activation component of the syringe-type material supply device of the present invention at a point in time predetermined by a user—such as, for example, by applying pressure on the syringe connecting body in the direction of the syringe body—the dental material is released and moves via the influence of a vacuum through the syringe connecting body. By the holding in readiness of the activation component, while a vacuum is applied therethrough, air is removed from the dental material prior to the actuation which effects the dispensing of the dental material. This particular pre-de-gassing operation permits the situation in which entrapped air has already been removed from the material before its supply. In this connection, the benefit that a viscous dental material which has been subjected to a relatively long vacuum tends to separate out entrapped air can be particularly exploited.

In accordance with the present invention, it is particularly advantageous if a gap in the area of the outlet opening is provided for the activation component, wherein the gap is so dimensioned that the viscous dental material does not pass through the gap even in connection with a relatively long duration application of a vacuum while, on the other hand, air can freely pass through the gap. The gap can have a width, for example, of 2 micrometers up to 100 micrometers and, preferably, has a dimension of approximately 20 micrometers.

The gap dimension is configured in correspondence with the dental material which is to be used. The gap is dimensioned such that the gap is smaller in correspondence with decreasing viscosity of the material. It is to be understood that, in lieu of the gap, other desired suitable micro openings can be provided. For example, a plurality of openings in the manner of a sieve can be provided, whereby here also the cross sectional dimension of the opening is within the given range.

The syringe-type material supply device of the present invention permits multiple use for dispensing dental material with little or no cleaning required. The syringe-type material supply device can, as well, be thrown away after use. The activation component can be resiliently biased by a spring toward its closed or non-actuation position such that, in the event of decreasing pressure, the component has already been urged into its closed position in which it prevents the flow of dental material from the syringe body. Additionally, the syringe-type material supply device can be provided with a closing cap at the syringe connecting body, or at the end of the syringe body, which can be removed before use. Upon the application of a vacuum, the dental material in the syringe body and the syringe plunger are drawn toward the outlet of the syringe body such that the dental material is already positioned at the base of the outlet opening prior to the activation of the activation component.

In accordance with the present invention, it is particularly advantageous that the pre-de-gassing is substantially automatically operated, if the syringe-type material supply device is connected to a vacuum system. The dentist can make a vacuum connection and, after a relatively short waiting period, can be assured that entrapped air has been removed. Through the application of pressure on the activation component, the supply of the dental material automatically follows.

The syringe-type material supply device of the present invention is particularly suitable for a root canal filling material supplied from two different components which, upon activation of the activation component, are mixed with one another and delivered into a root canal dental restoration site.

The applied vacuum can be accommodated to a wide range of requirements. A vacuum of less than 500 millibar, and, in particular, a vacuum of approximately 100 millibar, are favorable and the vacuum preferably is introduced as well into the dental cavity such that the supplied dental material can flow uniformly into the dental cavity as is described in German Patent Application 100 640 005.2, which is hereby fully incorporated by this reference thereto. It is particularly favorable if the syringe-type material supply device of the present invention is configured as a disposable component.

The dental material which is used is preferably pasty and has a viscosity of 5 to 35 Pas, preferably 8 to 22 Pas, and especially preferably, 8 to 12 Pas. If a root canal filling material is to be used, the binding time of such material should be in the range of 5 to 300 minutes, more preferably 15 to 150 minutes, and most preferably 30 to 100 minutes.

The dental material can be a single component material which does not require mixing. The passage of the material through a static mixer is, however, also of advantage in connection with a single component material, as the material here is optimally de-gassed. Preferably, however, two components of a root canal filling material are cross-mixed with one another and de-gassed. The mixing ratio can be variable such as, for example, 1:1, 1:2, 1:4 to 1:10. In any event, more than two components can be supplied.

The syringe-type material supply device can be configured as a unit for multiple use. The outlet is then preferably closed by a cap, whereby the syringe connecting body is preferably configured as a disposable item.

### BRIEF DESCRIPTION OF THE DRAWINGS

The object and advantages of the present invention will be explained in more detail with the aid of the accompanying drawings, in which:

FIG. 1 is a perspective exploded view of one embodiment of the syringe-type material supply device of the present invention;

FIG. 2 is a sectional view of the one embodiment of the syringe-type material supply device shown in FIG. 1; and

FIG. 3 is a sectional view of the one embodiment of the syringe-type material supply device shown in FIG. 1, showing the syringe-type material supply device in its material supply operation.

### DETAILED DESCRIPTION OF THE PREFERRED EMBODIMENT

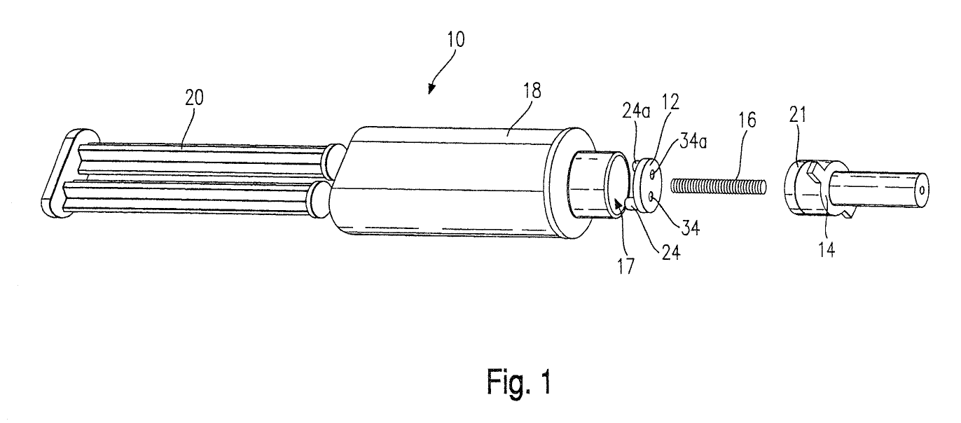

As seen in FIG. 1, a syringe-type material supply device 10 is shown in an exploded perspective view. In accordance with the present invention, dental material is received in a syringe body 18. In the illustrated embodiment, the syringe body 18 is configured as a two-component syringe body which permits the receipt of a separate dental material component in each respective syringe channel. Accordingly, a syringe plunger is configured as a double plunger 20 in the embodiment shown in FIG. 1.

The syringe body 18 includes an outlet 17. An activation component 12 is disposed at the outlet 17 and, in accordance with the present invention, is configured in a specific manner. The activation component 12 is configured to activate a syringe connecting body 14. In the illustrated embodiment, the activation component 12 rests against the syringe connecting body 14.

The syringe connecting body 14 further accommodates a mixing element which, in particular, is configured as a static mixer 16 having an outside diameter which is accommodated to the inner diameter of the syringe connecting body 14. The static mixer 16 has a spiral configuration and comprises a spring wire made of a corrosion proof material or of plastic. One end of the wire is connected to the injector of the syringe connecting body 14 by a turning connector (not shown), so that the static mixer 16 cannot be rotated. For cleaning purposes, the static mixer is easily removable from the syringe connecting body 14.

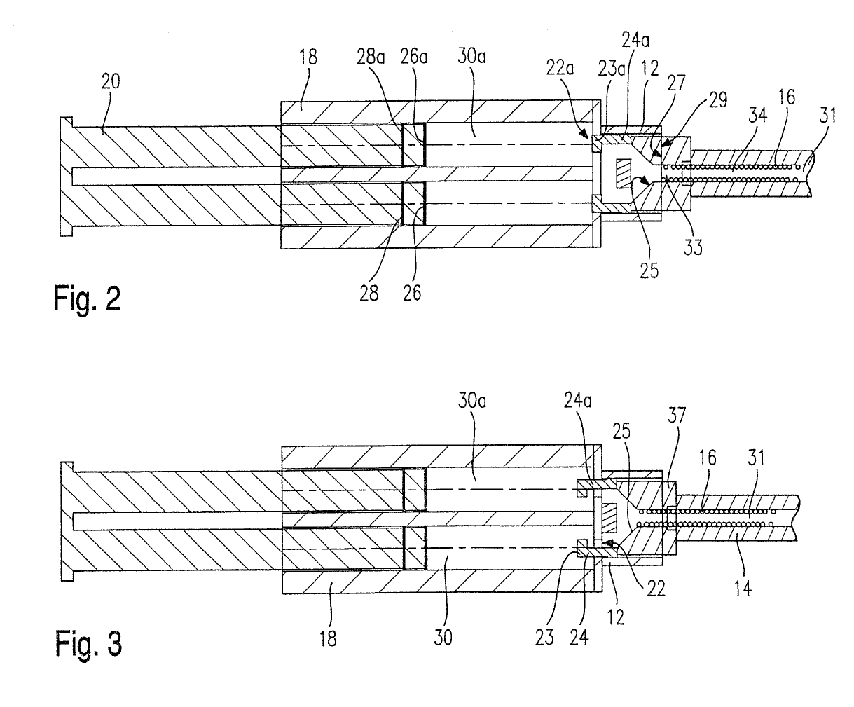

The activation component 12 is, in accordance with the present invention, configured in a particular manner. The activation component includes projections 24 and 24a which serve to connect the activation component and close off the outlet openings and whose configuration is shown in detail in FIGS. 2 and 3. The activation component 12 further includes openings 34 and 34A, which are configured for the passage therethrough of dental material.

As can be seen in FIG. 2, the activation component operates in the syringe-type device of the present invention in the following manner. As seen in FIG. 2, which illustrates the operational condition of the syringe-type material supply device 10 prior to the actuation of the activation component, the outlet openings 22 and 22a at the outlet 17 of the syringe body 18 are closed by closing elements 23 and 23a of the projections 24 and 24a, respectively, of the activation component 12. The diameter of each closing element 23 and 23a is accommodated to the diameter of each outlet opening 22 and 22a, whereby, however, a gap of a few micrometers is provided. Air or moisture can pass through this gap while the dental material components 30 and 30a retained in the inner-space of the syringe body 18 cannot, due to their viscosity, pass through the gap.

The syringe connecting body 14 has its outer diameter accommodated to the diameter of the outlet 17 and thus is sealed to the outlet. The syringe connecting body 14 includes a sealing ring 21 molded onto the syringe connecting body. For improved sealing off of the outlet, the inner wall of the outlet is provided with another sealing ring (not shown) which is, in any event, preferably molded thereonto. The rear surfaces 27 and 29 of the syringe connecting body 14 and the activation component 12 are also configured with respect to one another and are sealed against pressure.

In the operational condition of the syringe-type device shown, a vacuum or under-pressure is applied through an inner channel 31 of the syringe connecting body 14 into the inner space of the activation component 12. A uniform vacuum is created in this inner space of the activation component which extends through the respective ring gap between the closing elements 23 and 23a as well as the outlet openings 22 and 22a. The vacuum is applied through this gap into the inner space of the syringe body 18 and serves to effect the de-gassing of the dental material components 30 and 30A in the syringe body 18 or, respectively, the evacuation of air from the syringe body 18.

The tube component plunger has, at its end, two conventional respective sealing rings 26 and 28 or, respectively, 26a and 28a. In connection with the evacuation of air, the air in the inner space between the outlet 17 and the plunger 20 is suctioned out and the plunger 20 is moved to the right so that the dental material at the level of the outlet openings 22, 22a is in an air-free condition.

As shown in FIG. 3, to effect the actuation of the activation component 12, a relative pressure between the syringe connecting body 14 and the syringe body 18 is exerted. The activation component 12 is pressed into the outlet 17 by this relative pressure. The closing elements 23 and 23a are moved out of engagement in the outlet openings 22 and 22a, which are thus placed into open conditions. The dental material 30 and 30a, with their respective components can flow out into the area of the conical inner space 25 of the activation component 12. Due to the existing inner pressure, the dental material flows further through the inner channel 31 of the syringe connecting body 14 and is cross-mixed by the static mixer and, at the same time, de-gassed. A curable single component material is thus produced from the two dental material components.

The projections 24 and 24a are preferably somewhat tapered in order to facilitate the passage of the filling material out of the outlet openings 22 and 22a.

It is to be understood that other suitable configurations can be provided in order to make possible the desired passage and sealing off between the activation component 12, on the one hand, and the syringe body 18, on the other hand.

It is to be understood that the invention is not limited to use as a two-component needle. Instead, as required, the syringe-type device of the present invention can be configured as a simple one component syringe body or as a three- or even a four-component syringe body as required.

The present invention is, of course, in no way restricted to the specific disclosure of the specification and drawings, but also encompasses any modifications within the scope of the appended claims.

What is claimed is:

1. A syringe-type device for supplying dental material to a dental restoration site, comprising:
a syringe body having an outlet and a dental material retaining space for retaining therein a dental material which is forced through the outlet by the relative movement between the syringe body and a plunger inserted therein;
a syringe connecting body having an upstream opening and a downstream opening, the syringe connecting body being connectable to the syringe body such that dental material which has exited the syringe body through the outlet thereof flows through the upstream opening into the syringe connecting body and subsequently flows through the downstream opening to the dental restoration site; and
an activation component disposable relative to the outlet of the syringe body and the upstream opening of the syringe connecting body such that the activation component, in a non-actuated condition thereof, at least partially blocks the flow of dental material from the syringe body into the syringe connecting body and, in an actuated condition thereof, permits a relatively greater flow of dental material from the syringe body into the syringe connecting body than in its non-actuated condition, and the activation component being movable from its non-actuated condition to its actuated condition by movement of the activation component and the syringe body relative to one another.

2. A syringe-type device according to claim 1, wherein the activation component is disposed on the syringe body and, especially, is movable in the direction of the axis of the syringe body.

3. A syringe-type device according to claim 1, wherein the activation component closes the outlet of the syringe body in a substantially complete but non-air sealing manner.

4. A syringe-type device according to claim 1, wherein the activation component includes at least one opening.

5. A syringe-type device according to claim 1, wherein the outlet of the syringe body includes two outlet openings and the activation component includes at least two closing elements, which extend into the outlet openings of the outlet of the syringe body and which, upon actuation of the activation component, are moved out of the outlet openings such that these outlet openings are open for the passage of dental material therethrough.

6. A syringe-type device according to claim 1, wherein the activation component is actuable through pressure on the syringe connecting body and thereby effects the opening of the outlet openings of the syringe body.

7. A syringe-type device according to claim 1, wherein the syringe body is configured as a two-component syringe body operable with a two-component plunger, and the syringe connecting body includes a static mixer.

8. A syringe-type device according to claim 1, wherein the syringe connecting body is axially movable in the outlet in a sealing manner.

9. A syringe-type device according to claim 7, wherein the static mixer effects a cross-mixing of the dental materials.

10. A syringe-type device according to claim 1, wherein the syringe connecting body is connected to a vacuum connection and the air in the syringe body can be evacuated through a gap between the closing elements and the sealing elements of the activation component in the non-actuated condition of the activation component.

11. A syringe-type device according to claim 1, wherein the activation component is movable via a vacuum applied through the syringe connecting body.

12. A syringe-type device according to claim 1, wherein the activation component includes a pair of projections, the syringe body includes a pair of outlet openings, and at least one of the projections and the outlet openings includes a recess for receipt of the dental material.

13. A syringe-type device according to claim 1, wherein the activation component closes the outlet of the syringe body in an air-tight manner.
